(19) United States
(12) Patent Application Publication
(10) Pub. No.: US 2023/0141588 A1
(43) Pub. Date: May 11, 2023

(54) SYSTEM AND METHOD FOR CONFIGURING AUGMENTED REALITY ON A WORKSITE

(71) Applicant: Caterpillar Paving Products Inc., Brooklyn Park, MN (US)

(72) Inventor: Brian D Nagel, Ramsey, MN (US)

(73) Assignee: Caterpillar Paving Products Inc., Brooklyn Park, MN (US)

(21) Appl. No.: 17/524,395

(22) Filed: Nov. 11, 2021

(51) Int. Cl. G06Q 10/06; G06K 9/00; G05D 1/00; G06T 19/00

(52) U.S. Cl. CPC G06Q 10/06316; G06Q 10/063114; G06Q 10/0633; G06K 9/00671; G05D 1/0044; G06T 19/006; G05D 2201/0202

(57) ABSTRACT

An augmented-reality device operating at a worksite obtains context data and worksite data relating to a user and a machine associated with the user. Based on a job role and a machine type identified for the user from the context data, a visual overlay for a mixed-reality display is selected from a plurality of visual overlays. The selected visual overlay is displayed for a scene in a window of the augmented-reality device in coordination with real-world images and status data, which is derived from the worksite data and also based on the job role and the machine type. While operating the machine, the user can view the selected visual overlay and status data, which may change for a new job role or machine.

### TECHNICAL FIELD

The present disclosure relates to a method for generating an overlay for a scene viewable in an augmented-reality device based at least on a job role of a user operating the augmented-reality device. More specifically, the present disclosure relates to a system including a work machine, an augmented-reality device, and an electronic controller configured to generate an augmented-reality overlay specific to a job role of a user and to the work machine associated with the user.

### BACKGROUND

Work machines can help move, shape, and reconfigure terrain within a worksite. For instance, at a paving worksite, one or more pieces of paving equipment, such as a cold planer, can be used to remove a portion of a roadway, parking lot, or other such work surface in order to expose a paving surface. Once the portion of the work surface has been removed, a paving machine, such as an asphalt paver, may distribute, profile, and partially compact heated paving material (e.g., asphalt) onto the paving surface. One or more compaction machines may then be used to further compact the paving material until a desired paving material density has been reached.

Augmented-reality devices may be used to assist a user in operating work machines at a worksite. Augmented reality refers to technology that begins with a real-world view of a physical environment through an electronic device and augments that view with digital content. Often, an augmented-reality device is a head-mounted display, commonly in the form of computerized smart glasses, although other implementations are available. With appropriate programming, an augmented-reality device used at a worksite may alert a user to hazards in a project, such as the location of power lines, pipes, manhole covers, or other items within a paving worksite.

One approach for using augmented-reality devices within a worksite is described in U.S. Pat. No. 10,829,911 (“the '911 patent”). The '911 patent describes a virtual assistance system including an augmented-reality display for assisting a work machine in grading a worksite. Various modules associated with the virtual assistance system indicate the presence of hazards within the worksite, which are then emphasized within the augmented-reality display. The emphasis may occur by augmenting, overlaying, or superimposing additional visual objects within a machine operator's view of the physical worksite. The '911 patent, however, is directed only to use of the augmented-reality display by the machine operator. A large worksite can have many personnel with varying roles or responsibilities who may benefit from an augmented-reality display, which the '911 patent does not contemplate. As a result, the system of the '911 patent is not desirable for augmented-reality devices that must be adapted for different modes of operation according to the role of the user, such as may exist with various personnel within a large worksite.

Examples of the present disclosure are directed to overcoming deficiencies of such systems.

### SUMMARY

In an aspect of the present disclosure, a computer-implemented method includes receiving, by an electronic controller, an indication of activation of an augmented-reality device associated with a user at a worksite and obtaining context data relating to usage of the augmented-reality device at the worksite, where the context data includes a user identity for the user. The method further includes identifying, by the electronic controller, a first job role associated with the user identity within the worksite for the augmented-reality device and generating an augmented-reality overlay for the augmented-reality device specific to the user based at least in part on the first job role. The electronic controller causes a first modification of a mixed-reality display of real-world images for a scene within a window of the augmented-reality device viewable by the user. The first modification includes the augmented-reality overlay visually coordinated with the real-world images and differs between the first job role and a second job role.

In another aspect of the present disclosure, a computer-implemented method includes receiving, by an electronic controller, user data identifying a user of an augmented-reality device at a worksite, identifying a job role for the user at the worksite, and receiving machine data identifying a work machine associated with the user at the worksite. The electronic controller selects a visual overlay among a plurality of a visual overlays available for a scene viewable within the augmented-reality device at least in part on a combination of the job role and the work machine. Further, the method includes receiving, by the electronic controller, worksite data relating to operation of the work machine by the user at the worksite and filtering the worksite data into status data based at least in part on a combination of the job role and the work machine. Additionally, the electronic controller causes a modification of a mixed-reality display of real-world images for the scene within a window of the augmented-reality device viewable by the user, where the modification for the scene includes the visual overlay coordinated with the real-world images and the status data, and where the modification is specific to the job role and the work machine.

In yet another aspect of the present disclosure, a system includes a work machine operable on a worksite by a user, an augmented-reality device associated with the user, and an electronic controller, coupled to at least the augmented-reality device. The electronic controller is configured to receive a user identity for the user of the augmented-reality device at the worksite, identify a first job role associated with the user identity within the worksite for the augmented-reality device, and generate an augmented-reality overlay for the augmented-reality device specific to the user based at least in part on the first job role. Moreover, the electronic controller of the system is configured to cause a modification of a mixed-reality display of real-world images for a scene within a window of the augmented-reality device viewable by the user. The modification includes the augmented-reality overlay visually coordinated with the real-world images and differs between the first job role and a second job role.

### BRIEF DESCRIPTION OF DRAWINGS

FIG. 1 is a perspective view of a system (e.g., a paving system) within a worksite in accordance with an example of the present disclosure.

FIG. 2 is a functional diagram of a representative flow of information within a worksite of FIG. 1 in accordance with an example of the present disclosure.

FIG. 3 is a flow chart depicting a method for a system to configure an augmented-reality device based on a context within a worksite in accordance with an example of the present disclosure.

FIG. 4 is an example view without augmented reality of a street to be milled in accordance with an example of the present disclosure.

FIG. 5 is an example view with augmented reality by a mill operator of a street to be milled in accordance with an example of the present disclosure.

FIG. 6 is an example view with augmented reality by a jobsite inspector of a street to be paved in accordance with an example of the present disclosure.

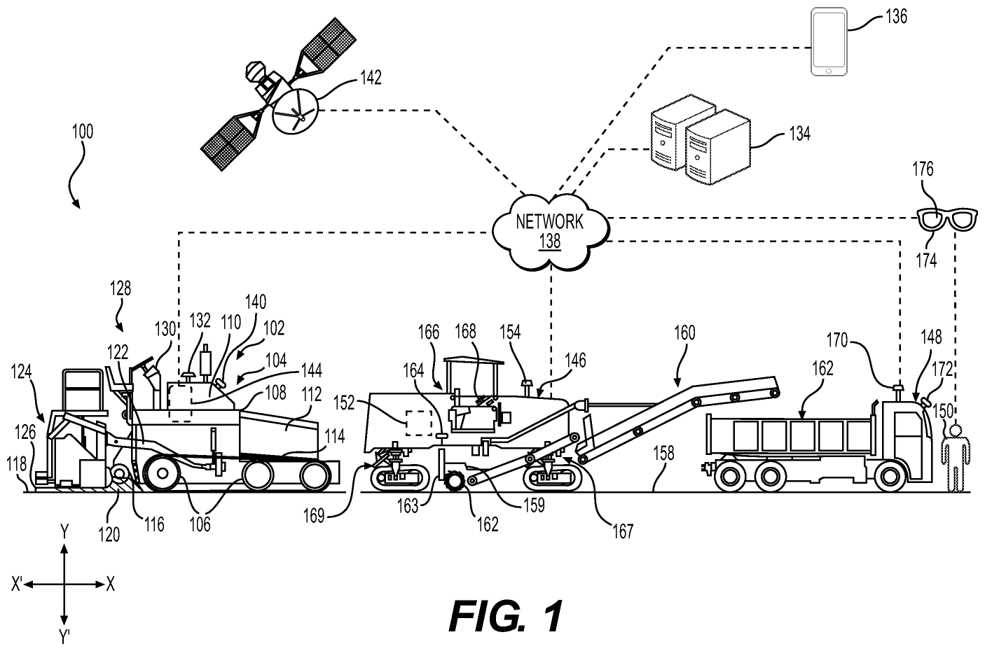

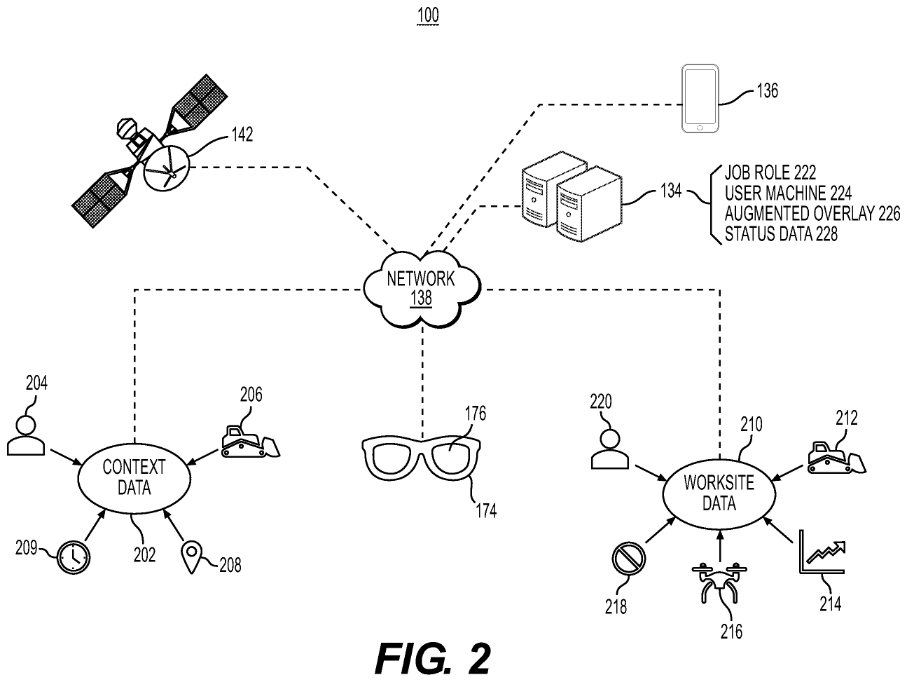

### DETAILED DESCRIPTION

Wherever possible, the same reference numbers will be used throughout the drawings to refer to same or like parts. The present disclosure begins with a discussion of an example system 100 (e.g., a paving system 100) depicted in FIG. 1. While discussed with reference to system 100 in FIG. 1, the principles of the present disclosure are applicable beyond system 100 to other work environments and settings benefitting from augmented-reality devices with multiple modes of operation. FIGS. 2-6 provide more explanation of the concepts within this disclosure.

Turning first to FIG. 1, the example paving system 100 includes at least one example machine configured for use in one or more milling, excavating, hauling, compacting, paving, or other such processes. Within that environment, an augmented-reality device assists a user with performing a job function within paving system 100. The augmented-reality device, such as smart glasses as discussed in more detail below, provides a real-world view of a physical environment within paving system 100 and augments that view through a display with digital information. The digital information within the display can include superimposed highlighting or emphasis on part of the physical environment, data, text, graphics, holograms, avatars, or other digital content that supplements the view. The digital information is superimposed to coordinate or coincide with the location of corresponding physical objects within the view. Moreover, in examples discussed below, the augmented-reality device can alter its behavior and its display of digital content based at least on the job role of its user. For instance, an operator of a work machine within system 100 may see different superimposed images within the augmented-reality device than a supervisor or a visitor to the worksite using the same augmented-reality device. FIG. 1 provides a framework for further addressing these concepts.

The example paving system 100 in FIG. 1 may include a paving machine 102 which may be used for road or highway construction, parking lot construction, and other allied industries. Alternatively, the paving machine 102 may be any other machine used for depositing heated asphalt, concrete, or like materials. The paving machine 102 may also include a hopper 112 for storing paving material. The paving machine 102 may further include a conveyor system 114 for conveying the paving material from the hopper 112 to other downstream components of the paving machine 102. For example, the paving machine 102 may include an auger assembly 116 that receives the paving material supplied via the conveyor system 114 and distributes the paving material onto a paving surface 118. Such paving material is illustrated as item 120 in FIG. 1. In such examples, the auger assembly 116 may be configured to distribute the paving material 120 across substantially an entire width of the paving machine 102.

Further referring to FIG. 1, an operator station 128 may be coupled to the tractor portion 104. The operator station 128 may include a console 130 and/or other levers or controls for operating the paving machine 102. For example, the console 130 may include a control interface for controlling various functions of the paving machine 102. The control interface may support other functions including, for example, sharing various operating data with one or more other machines of the paving system 100. In some examples, a display of the control interface may be operable to display a worksite map that identifies at least part of a paving surface and/or one or more objects located beneath the paving surface.

As shown, the paving machine 102 may also include a communication device 132. Such communication devices 132 may be configured to permit wireless transmission of a plurality of signals, instructions, and/or information between the paving machine 102 and various other machines of the paving system 100. The communication device 132 may also be configured to permit wireless transmission of a plurality of signals, instructions, and/or information between the paving machine 102 and one or more servers, processors, computers, and/or other controllers 134, one or more tablets, computers, cellular/wireless telephones, personal digital assistants, mobile devices, or other electronic devices 136, and/or other components of the paving system 100.

The controller 134 illustrated in FIG. 1 may be located at the worksite proximate the paving machine 102, at a remote paving material plant, at a remote command center (not shown), and/or at any other location. In any of the examples described herein, the functionality of the controller 134 may be distributed so that certain operations are performed at the worksite and other operations are performed remotely. For example, some operations of the controller 134 may be performed at the worksite, on one or more of the paving machines 102, haul trucks, cold planers, and/or other components of the paving system 100. It is understood that the controller 134 may comprise a component of the paving system 100.

The controller 134 may be a single processor or other device, or may include more than one controllers or processors configured to control various functions and/or features of the paving system 100. As used herein, the term “controller” is meant in its broadest sense to include one or more controllers, processors, and/or microprocessors that may be associated with the paving system 100, and that may cooperate in controlling various functions and operations of the components (e.g., machines) of the paving system 100. The functionality of the controller 134 may be implemented in hardware and/or software without regard to the functionality.

The one or more electronic devices 136 may also comprise components of the paving system 100. Such electronic devices 136 may comprise, for example, mobile phones, laptop computers, desktop computers, and/or tablets of project managers (e.g., foremen) overseeing daily paving operations at the worksite and/or at the paving material plant. Such electronic devices 136 may include and/or may be configured to access one or more processors, microprocessors, memory, or other components. In such examples, the electronic devices 136 may have components and/or functionality that is similar to and/or the same as the controller 134.

The network 138 may be a local area network (“LAN”), a larger network such as a wide area network (“WAN”), or a collection of networks, such as the Internet. Protocols for network communication, such as TCP/IP, may be used to implement the network 138. Although embodiments are described herein as using a network 138 such as the Internet, other distribution techniques may be implemented that transmit information via memory cards, flash memory, or other portable memory devices. The network 138 may implement or utilize any desired system or protocol including any of a plurality of communications standards. The desired protocols will permit communication between the controller 134, the electronic devices 136, the various communication devices 132 described herein, and/or any other desired machines or components of the paving system 100. Examples of wireless communications systems or protocols that may be used by the paving system 100 described herein include a wireless personal area network such as Bluetooth RTM (e.g., IEEE 802.15), a local area network such as IEEE 802.11b or 802.11g, a cellular network, or any other system or protocol for data transfer. Other wireless communication systems and configurations are contemplated.

In example embodiments, one or more machines of the paving system 100 (e.g., the paving machine 102) may include a location sensor 140 configured to determine a location and/or orientation of the respective machine. In such embodiments, the communication device 132 of the respective machine may be configured to generate and/or transmit signals indicative of such determined locations and/or orientations to, for example, the controller 134, one or more of the electronic devices 136, and/or to the other respective machines of the paving system 100. In some examples, the location sensors 140 of the respective machines may include and/or comprise a component of global navigation satellite system (GNSS) or a global positioning system (GPS). Alternatively, universal total stations (UTS) may be utilized to locate respective positions of the machines. One or more additional machines of the paving system 100 may also be in communication with the one or more GPS satellites 142 and/or UTS, and such GPS satellites 142 and/or UTS may also be configured to determine respective locations of such additional machines. In any of the examples described herein, machine locations determined by the respective location sensors 140 may be used by the controller 134, one or more of the electronic devices 136, and/or other components of the paving system 100 to coordinate activities of the paving machine 102, one or more cold planers, and/or other components of the paving system 100.

The paving machine 102 may also include a controller 144 operably connected to and/or otherwise in communication with the console 130, the communication device 132, and/or other components of the paving machine 102. The controller 144 may be a single controller or multiple controllers working together to perform a variety of tasks. The controller 144 may embody a single or multiple processors, microprocessors, field programmable gate arrays (FPGAs), digital signal processors (DSPs), and/or other components configured to calculate and/or otherwise determine one or more travel paths of the paving machine 102, screed settings, and/or other operational constraints of the paving machine 102 based at least in part on information received from the one or more other machines of the paving system 100, paving machine operating information received from an operator of the paving machine 102, one or more signals received from the GPS satellites 142, and/or other information. Numerous commercially available processors or microprocessors can be configured to perform the functions of the controller 144.

As shown in FIG. 1, the paving system 100 may further include one or more cold planers 146 and one or more haul trucks 148. In such examples, a cold planer 146 may include a controller 152 that is substantially similar to and/or the same as the controller 144 described above with respect to the paving machine 102. In such examples, the controller 152 of the cold planer 146 may be in communication with the controller 144 of the paving machine 102 via the network 138.

The cold planer 146 may further include one or more rotors 156 having ground-engaging teeth, bits, or other components configured to remove at least a portion of the roadway, pavement, asphalt, concrete, gravel, dirt, sand, or other materials of a work surface 158 on which the cold planer 146 is disposed. The cold planer 146 may also include a conveyor system 160 connected to the frame 159, and configured to transport removed portions of the work surface 158 from proximate the rotor 156 (or from proximate the first and second rotors) to a bed 162 of the haul truck 148. Additionally, the cold planer 146 may include an actuator assembly 163 connected to the frame 159 and configured to move the rotor 156 (or to move the first and second rotors) relative to the frame 159 as the rotor 156 removes portions of the work surface 158.

In addition to and/or in place of the actuator assembly 163 associated with the rotor 156, the cold planer 146 may include a front actuator assembly 167 and a rear actuator assembly 169. In such examples, the front actuator assembly 167 may be connected to the frame 159, and configured to raise and/or lower one or more wheels, continuous tracks, or other ground engaging elements (disposed at the front of the cold planer 146) relative to the frame 159. Similarly, the rear actuator assembly 169 may be connected to the frame 159, and configured to raise and lower one or more wheels, continuous tracks, or other ground engaging elements (disposed at the rear of the cold planer 146) relative to the frame 159.

As shown in FIG. 1, the cold planer 146 may further include one or more GPS sensors or other like location sensor 164 configured to determine a location of the cold planer 146 and/or components thereof. In example embodiments, a location sensor 164 connected to the frame 159 of the cold planer 146 may be configured to determine GPS coordinates (e.g., latitude and longitude coordinates), grid coordinates, a map location, and/or other information indicative of the location of the cold planer 146, in conjunction with the one or more GPS satellites 142 described above. In such examples, the controller 152 of the cold planer 146 and/or the controller 144 of the paving machine 102 may determine corresponding GPS coordinates of the axially outermost edges (e.g., a left edge and a right edge) of the rotor 156 based at least in part on the information (e.g., GPS coordinates) indicative of the location of the cold planer 146.

The cold planer 146 may also include an operator station 166, and the operator station 166 may include a console 168 and/or other levers or controls for operating the cold planer 146. In some examples, the operator station 166 and/or the console 168 may be substantially similar to the operator station 128 and console 130 described above with respect to the paving machine 102. For example, the console 168 may include a control interface for controlling various functions of the cold planer 146 including, for example, sharing various operating data with one or more other machines of the paving system 100.

With continued reference to FIG. 1, the haul truck 148 may comprise any on-road or off-road vehicle configured to transport paving material 120, removed portions of the work surface 158, and/or other construction materials to and from a worksite. For instance, similar to the cold planer 146 and the paving machine 102, the haul truck 148 may include a set of wheels or other ground-engaging elements, as well as a power source for driving the ground-engaging elements. As noted above, the haul truck 148 may include a bed 162 configured to receive removed portions of the work surface 158 from the cold planer 146 and/or to transport paving material 120.

In addition, the haul truck 148 may include a communication device 170 and a location sensor 172. The communication device 170 may be substantially similar to and/or the same as the communication devices 132, 154 described above, and the location sensor 172 may be substantially similar to and/or the same as the location sensors 140, 164 described above.

The worksite, in the form of paving system 100, may additionally include one or more devices providing “augmented reality” or “augmented vision” for a user 150, shown in FIG. 1 as augmented-reality device 174. Augmented-reality device 174 is a display device in which a user's perception or view of the real, physical world is augmented with additional informational input. That input may include additional information about the scene or focus currently viewed by the observer. Augmented-reality device 174 is sometimes referred to as a “heads-up display” because it enables operators to view augmentation data without having to move their head. Augmented-display device 174 includes a display screen 176 on which the augmentation content is shown. Display screen 176 can be disposed in the operator's line of view as indicated by the location of the operator's eyes 164. Accordingly, the display screen will be generally transparent but may be modified to also show augmented input as described below. Augmented-reality device 174 may take other suitable forms. In one implementation, augmented-reality device 174 is a head mounted display (HMD) with a visor or goggles having transparent lenses that function as display screen 176 through which the wearer views the surrounding environment.

One current commercial option for augmented-reality device 174 is a set of HoloLens smart glasses available from Microsoft Corporation of Redmond, Washington. HoloLens devices are head-mounted, mixed-reality smart glasses. Among other features, HoloLens is an untethered holographic device that includes an accelerometer to determine linear acceleration along the XYZ coordinates, a gyroscope to determine rotations, a magnetometer to determine absolute orientation, two infrared cameras for eye tracking, and four visible light cameras for head tracking. As such, the HoloLens includes advanced sensors to capture information about what the user is doing and the environment the user is in. HoloLens includes network connectivity via Wi-Fi and may be paired with other compatible devices using Bluetooth. A custom processor, or controller, enables the HoloLens to process significant data from the sensors and handle affiliated tasks such as spatial mapping.

As with other devices within paving system 100, augmented-reality device 174 may be in communication with controller 134 via the network 138, such as through its ability to establish a Wi-Fi connection. With this communication, augmented-reality device 174 or controller 134 may provide or generate spatial mapping information relating to a geographic region, such as the worksite of paving system 100. Spatial mapping provides a detailed representation of real-world surfaces in the environment around augmented-reality device 174. The spatial mapping helps anchor objects in the physical world so that digital information can be accurately coordinated with them when augmented within a display. In some examples, a map of the terrain of a worksite associated with paving system 100 may be retrieved from an external source for use by augmented-reality device 174. In other examples, augmented-reality device 174 collects data through its cameras and builds up a spatial map of the environment that it has seen over time. As the physical environment changes, augmented-reality device 174 can update the map as its cameras collect information that the wearer sees.

Either controller 134 or augmented-reality device 174 can retain a map of the worksite usable by augmented reality device 174. In operation, augmented-reality device 174, through its many sensors and cameras, can identify a physical scene within a field of view of user 150, as wearer of the glasses, that corresponds with the map. As the field of view of user 150 changes, the relevant data from the spatial map associated with what is seen by user 150 through display screen 176 also changes.

Augmented-reality device 174 enables the programming of digital information to be superimposed or augmented over the view of the physical world within display screen 176. In particular, selected physical objects seen through display screen 176 in the physical domain may be highlighted or emphasized with graphics in the digital domain. Knowing the coordinates of the selected physical objects from the spatial mapping data, augmented-reality device 174 can coordinate the positioning of the graphics within display screen 176 so the two align. In some examples, the graphics are superimposed with highlighting. In other examples, the graphics include holograms or other graphics sufficient to communicate desired information to user 150.

Although not depicted in FIG. 1, it will be apparent that the worksite of paving system 100 can include numerous obstacles or hazards that may affect the efficient and safe operation of paving machine 102, cold planer 146, or haul truck 148. These may include overhead power lines that could impair safe movement of the equipment, manholes and manhole covers within the milling or paving path, ditches or other gradients at the side of the paving path, equipment within the worksite, personnel on the ground near the paving path, vehicles traveling near the paving path, and other obstacles. These hazards may be identified in any physical dimensions within the worksite, such as on work surface 158, under work surface 158, to the side of one of paving machine 102, cold planer 146 or haul truck 148, or above work surface 158. In some examples, augmented-reality device 174 identifies one or more of these hazards as they appear within display screen 176 during operation of paving machine 102, cold planer, 146, and haul truck 148. Accordingly, as user 150 wears augmented-reality device 174 and sees the physical world in display screen 176 through a field of view that includes one or more of these hazards, augmented-reality device 174 adds digital information to emphasize or highlight the hazards to user 150.

Besides potential hazards, augmented-reality device 174 in some examples highlights with digital information objects within the field of view significant to a work function of user 150. For example, when user 150 is an operator of cold planer 146, based on the current position and field of view of user 150, augmented-reality device 174 may help identify areas of work surface 158 yet to be treated. Sensors other than those within augmented-reality device 174, at least as discussed above within paving system 100, may be used to collect information about the location, perspective, and terrain relative to a field of view of user 150.

While FIG. 1 illustrates a general environment for implementation of augmented-reality device 174 within a worksite, FIG. 2 shows an example of information flow within the example of paving system 100 consistent with the principles of the present disclosure. As discussed above with respect to FIG. 1, paving system 100 includes one or more devices configured to collect, store, share, deliver, and process data associated with the worksite, including controller 134, electronic device 136, network 138, and satellite 142. From within paving system 100, one type of available data is context data 202, which in some examples is data characteristic of a context for the operation of augmented-reality device 174. Context data 202 may arise from numerous devices and situations within paving system 100, have different types and forms, and be stored and delivered in a plurality of ways. In some implementations, context data 200 is communicated between electronic processing and storage devices as part of the various work machines within paving system 100. Specifically, context data 202 may be generated or captured by and communicated from one or more of controller 144 and communication device 132 of paving machine 102, controller 152 and communication device 154 of cold planer 146 or a controller and communication device 170 of haul truck 148. Communication of context data 202 can occur between these work machines, to controller 134 by way of network 138, directly to augmented-reality device 174, or through any other communication path.

As embodied as 204 in FIG. 2, context data 202 includes a user identity. User identity 204 is a unique representation of a person currently associated with the use of augmented-reality device 174. User identity may be a login name, a company identification or employee number, a government identification code, or any type of sequence uniquely identifying user 150 of augmented-reality device 174. The user identity may be a combination of a username and password or other variation of codes chosen to avoid confusion or duplication of identities. In some examples, user identity 204 is entered directly into augmented-reality device 174. The entry could occur through interaction by user 150 with augmented-reality device 174 or augmented-reality device 174 could scan a retina of user 150 using one of its cameras to perform a type of biosecurity check for identification. In other examples, user identity 204 is provided through an application running on a computerized device, such as a person's smartphone or tablet, and communicated to network 138 or augmented-reality device 174 from the computerized device. Alternatively, user identity 204 is entered into a work machine operated by the person and communicated from that work machine to network 138 or augmented-reality device 174.

Machine identity 206 is another example of context data 202. Machine identity 206 specifies a particular machine or machine type associated with user 150 of augmented-reality device 174. Machine identity 206 in some situations is an alphanumeric code or other informational symbol communicating a make, type, and/or model of a work machine, such as a Caterpillar AP555F track asphalt paver or a Caterpillar PM620 cold planer. Machine identity 206 may be provided in various ways, such as through entry directly into augmented-reality device 174, through communication from a computerized device to controller 134 or augmented-reality device 174, or through communication from controller 144 or controller 152 on one of the work machines to controller 134 or augmented-reality device 174.

Context data 202 additionally includes location 208 and time 210. As discussed above for FIG. 1, the work machines or other devices within paving system 100, such as location sensor 140, may be in communication with one or more GPS satellites 142 and/or UTS, and such GPS satellites 142 and/or UTS may also be configured to determine respective locations of such machines or devices. Additionally, augmented-reality device 174 includes location sensing abilities and determines location 208 with respect to its position. Time 209 is determined within any of the controllers or electronic devices in paving system 100 as well as within augmented-reality device 174. Location 208 and time 209 is communicated to, if not already determined by, controller 134 and/or augmented-reality device 174 for use in paving system 100.

In addition to context data 202, electronic components within paving system 100 collect and communicate worksite data 210. In general, worksite data 210 includes operational data 212 relating to execution of work functions within paving system 100 collected from one or more operational sensors associated with the work machines and the worksite. In one example, system controller 134, electronic devices 136, and/or any other desired machines or components of paving system 100 may continuously or periodically send requests to communication device 132, communication device 154, or communication device 170 requesting data obtained from operational sensors (not shown). The operational sensors may detect any parameter such as, for example, light, motion, temperature, magnetic fields, electrical fields, gravity, velocity, acceleration in any number of directions, humidity, moisture, vibration, pressure, and sound, among other parameters. Thus, the operational sensors may include accelerometers, thermometers, proximity sensors, electric filed proximity sensors, magnetometer, barometers, seismometer, pressure sensors, and acoustic sensors, among other types of sensors. Corresponding operational data 212 associated with the type of sensor may be gathered. Thus, operational data 212 obtained via the operational sensors may be transmitted to controller 132 or controller 152, for example, for further transmission and/or processing. Examples of operational data 212 gathered from sensors include operator manipulation of the work machine, machine velocity, machine location, fluid pressure, fluid flow rate, fluid temperature, fluid contamination level, fluid viscosity, electric current level, electric voltage level, fluid (e.g., fuel, water, oil) consumption rates, payload level, and similar characteristics. In the example of FIGS. 1 and 2, paving machine 102, cold planer 146, and haul truck 148 can collect many other types of operational data 212, also termed telematics data, within the knowledge of those of ordinary skill in the art and communicate that data at least to controller 134 via network 138.

In the implementation of FIG. 2, worksite data 210 also includes production metrics 214. Production metrics 214 typically encompass data relevant to assessing the progress of a work task or workflow for a project, operator, or machine. For example, for a milling and paving project as in FIG. 1, a condition of work surface 158 and paving surface 118 may be measured to determine progress of the tasks for cold planer 146 and paving machine 102 within a worksite plan. Performance indicators determined from production metrics 214 may be used to identify underperforming machines within the worksite plan as well as to allow supervisors, foremen, managers, crew members, and other individuals associated with the worksite plan to know how far along the worksite plan has progressed and how much of the worksite plan may be left to complete. In some examples, production metrics 214 are used to evaluate a status of a workflow for a work machine, such as paving machine 102, cold planer 146, and haul truck 148, within an overall project and to identify steps within the workflow remaining for completion. The production metrics 214 may be processed by, for example, system controller 134 using on one or more data maps, look-up tables, neural networks, algorithms, machine learning algorithms, and/or other components to present the determine performance indicators and job status for the worksite.

In some examples, drone data 216 is part of worksite data 210. One or more drones in the air may collect unique information as drone data 216 about the worksite in the direction of the Y axis and about the worksite from a wide perspective. Drone data 216 can include information about the condition of work surface 158 and paving surface 118, a state of progress for the worksite, movement and status of equipment and personnel within the worksite, and other conditions within the knowledge and experimentation of those of ordinary skill in the field.

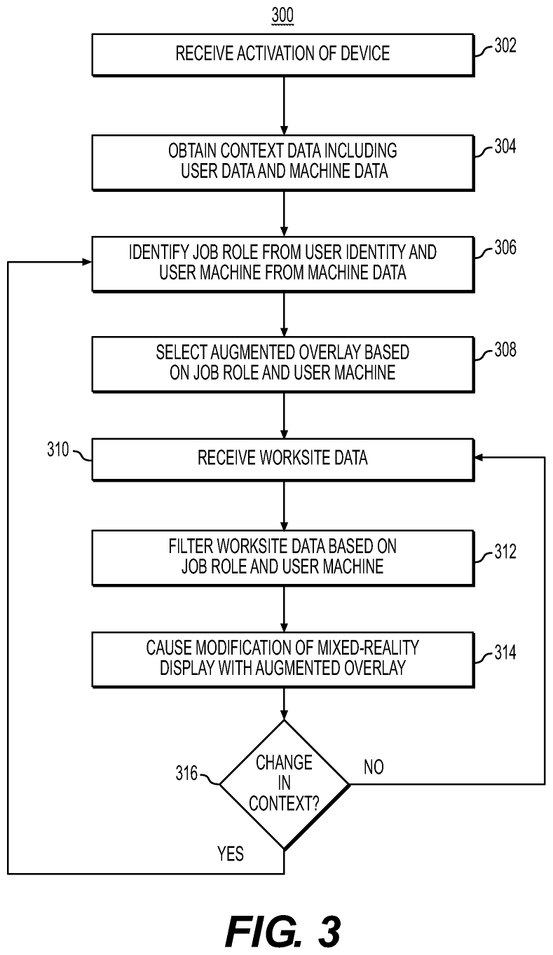

In the implementation of FIG. 2, worksite data 210 includes hazard data 218 and personnel status 220. Hazard data 218 includes information collected relating to objects within the worksite presenting a risk of injury or disruption to a workflow. Hazard data 218 can include underground hazards relating to the milling operation (such as manholes, electrical lines), ground-level hazards (such as manhole covers, ditches, personnel, vehicles), and above-ground hazards (such as power lines, bridges). An intersection of one of paving machine 102, cold planer 146, and haul truck 148 with objects identified in hazard data 218 could result in injury to personnel, damage to equipment, or at least interruption of the planned workflow. Similarly, personnel status 220 is data associated with the location, movement, and identification of personnel within the worksite. In one context, personnel status 220 may overlap with hazard data 218 in identifying people within the worksite who may be at risk of injury or disruption to a workflow. In another context, personnel status 220 provides information about the availability of resources within the worksite for completing a workflow. For example, personnel status 220 can identify the arrival of supplies to the worksite, such as an asphalt truck with more paving content or an emptied haul truck 148 returning to the worksite. As with other worksite data 210, hazard data 218 and personnel status 220 are typically communicated to controller 134 via network 138, or directly or indirectly to augmented-device 174, for storage, analysis, processing, and potential usage with augmented-reality device 174 in a manner discussed below in view of FIGS. 3-6.

While FIG. 2 depicts the flow of data in categories of context data 202 and worksite data 210 relevant to augmented-reality device 174 within a representative worksite such as paving system 100, FIG. 3 is a flowchart of a sample method for configuring augmented-reality device 174 consistent with implementations of the present disclosure. As generally summarized in FIG. 3, method 300 entails representative interactions between at least augmented-reality device 174 and controller 134 with respect to context data 202 and worksite data 210.

In particular, method 300 begins with a step 302 of receiving, by an electronic controller, an indication of activation of an augmented-reality device associated with a user at a worksite. In an example, a user turns on augmented-reality device 174, and the electronic controller within augmented-reality device 174 registers the activation of the device to begin operation. Alternatively, the electronic controller is controller 134, which receives the indication via network 138.

In a next step 304, the electronic controller obtains context data that includes user data and machine data. For instance, after activation, a controller, whether controller 134 or a controller within augmented-reality device 174, obtains context data 202 relevant to augmented-reality device 174, which includes at least user identity 204 and machine identity 206. As discussed above, user identity 204 may be affiliated with a login and authentication process for a user to use augmented-reality device 174, and machine identity 206 can be an identification of a particular work machine at the worksite associated with user 150, such as a work machine that user 150 will be operating. In some contexts, as explained below, context data 202 does not include machine identity 206, as user 150 is not associated with a specific machine. Other features of context data 202 may also be obtained by the controller, such as location 208 and time 209, although they are not elaborated on within method 300.

Following step 304, a job role 222 is identified for user 150 at the worksite from the user identity (step 306). A job role is a defined responsibility or function that a user has within the worksite. Typical job roles within the context of the present disclosure are operator, supervisor, inspector, and visitor. Fewer or more job roles may exist without departing from the disclosed and claimed processes. In this example, an operator is a job role in which user 150 controls or pilots operation of user machine 224, such as one of paving machine 102, cold planer 146, and haul truck 148. In this situation, the operator is able to affect steering, acceleration, stopping, starting, and numerous other functions associated with user machine 224. In some examples, job role is identified for user 150 by accessing a database that includes eligible users of augmented-reality device 174 and job roles associated with those users. A person within an enterprise whose occupation is to operate paving equipment such as cold planer 146 may be listed in the database as an operator. Another person may work in management and be listed in the enterprise database as a supervisor. Alternatively, paving system 100 may provide the option for a user of augmented-reality device 174 to enter a particular job role, such as directly into the augmented-reality device 174, through an electronic device 136, or by some other means as part of the login process. The level of access and control provided for associating a job role with a user is subject to the particular implementation and within the knowledge of those of ordinary skill in the art.

Step 306 also entails identifying a user machine from the machine data within the context data 202. A user machine 224 identified from machine data 206, as explained above, specifies in some examples a make, model, or type of equipment associated with user 150. Thus, if user 150 has a job role as an operator, that operator may further be currently associated with a Caterpillar PM620 cold planer in one situation. For other job roles, machine data 206 and identification of a user machine 224 under step 306 may not occur. Specifically, if job role 222 is an inspector or a visitor, the activity associated with that user is not tied to a particular machine necessarily. The variation in associating users with work machines depends on the implementation.

As reflected in FIG. 3, step 308 involves selecting, by the electronic controller, a visual overlay among a plurality of a visual overlays available for a scene viewable within the augmented-reality device. Augmented-reality device 174 includes software and the availability for programming of software to generate augmentations or overlays for display in conjunction with a view of the physical world. These overlays may appear as superimposed images, highlighting, holograms, or other emphases associated with objects within a scene viewed in the physical world. For any given scene within a physical space containing a mapping within augmented-reality device 174 or controller 134, multiple augmentations or overlays, or multiple variations to an augmentation or overlay, are possible. Rather that present a common overlay for any user of augmented-reality device 174, the present disclosure contemplates selecting an overlay or variations to an overlay among a plurality of visual overlays available for a scene. Moreover, as indicated in step 308, selecting a visual overlay includes selecting among the plurality based at least in part on a combination of job role 222 and user machine 224. Therefore, a visual overlay or augmented overlay 226 for use in augmenting reality, i.e., highlighting certain objects within the scene, is selected to suit job role 222 of user 150 and possibly also the user's tasks using user machine 224 associated with that user.

Continuing through FIG. 3, step 310 includes to receive worksite data relating to operation of user machine 224 by user 150 at the worksite, and step 312 is to filter that worksite data into status data based at least in part on a combination of job role 222 and user machine 224. For example, after receiving worksite data 210, such as one or more of operational data 212, performance metrics 214, and hazard data 218, a controller such as controller 134 processes the received data to select information relevant to the identified job role and work machine for user 150. In a situation where job role 222 is operator and user machine 224 is cold planer 146, controller 134 (or the controller within augmented-reality device 174) filters the received worksite data 210 for operational data 212, performance metrics 214, and hazard data 218 related to operation of cold planer 146 with a current workflow.

In step 314, a controller causes a modification of a mixed-reality display of real-world images for the scene within a window of the augmented-reality device viewable by user 150. The modification includes the augmented overlay 226 coordinated with the real-world images and status data 228 and is specific to job role 222 and user machine 224. In some implementations, a controller within augmented-reality device 174 (or controller 134) will cause display screen 176 to change the content within a field of view of a user for a scene by superimposing the augmented overlay 226 that is specific to job role 222 and user machine 224. Thus, for the example of an operator of cold planer 146, the controller will cause display screen 176 to show the highlighted objects determined for the augmented overlay 226 relevant to operation of that machine and to show the filtered worksite data 210 specific to the workflow happening for that machine.

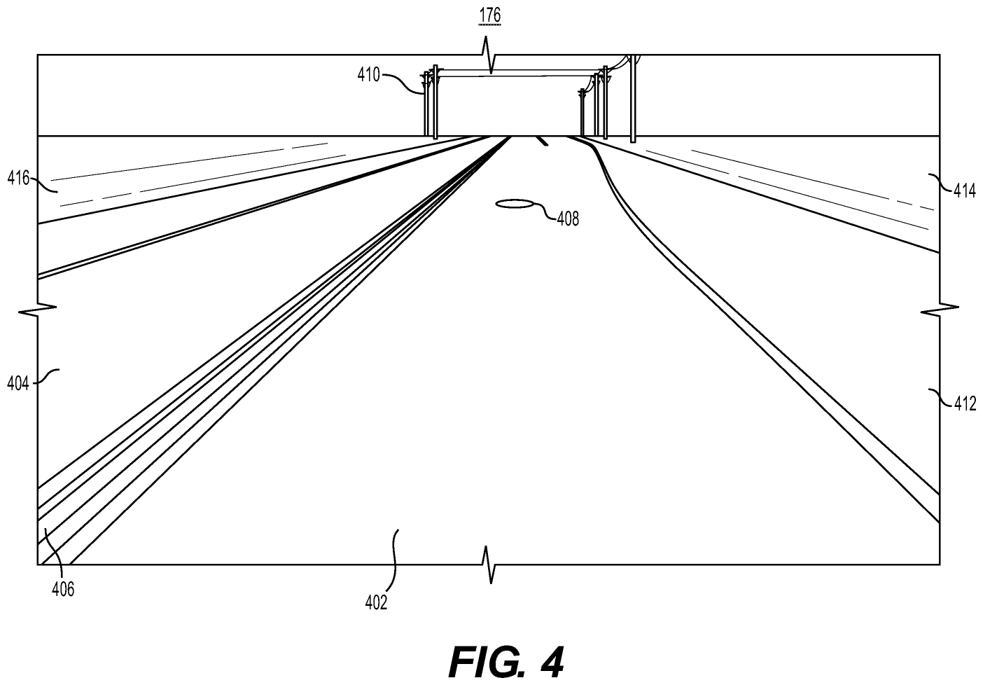

FIGS. 4-6, viewed in conjunction with the method of FIG. 3, help illustrate these selections of visual overlays and filtered worksite data. FIG. 4 is an example view through display screen 176 of augmented-reality device 174 of a lane 402 within a street to be milled and paved without augmentation. Oncoming lane 404 is separated from lane 402 by divider lines 406. A manhole cover 408 is within lane 402, and overhead power lines 410 go across the road in the distance. A berm 412 runs along the side of lane 402 and right roadside 414 and left roadside 416 border the street. This view of the street to be milled and paved in the physical world in FIG. 4 contains no augmentation as might be added by augmented-reality device 174.

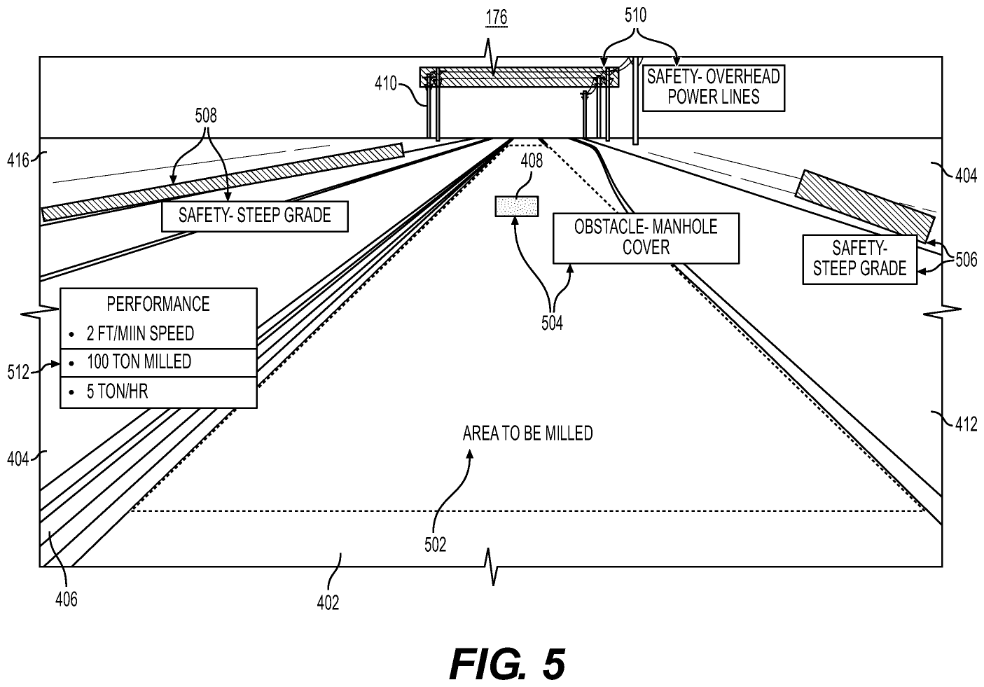

FIG. 5 illustrates the same view as FIG. 4 of the physical world through display screen 176, i.e., a street to be milled and paved, but with an overlay selected according to a job role of an operator for a work machine that is cold planer 146. Worksite data 210 received from the worksite is also filtered in this example according to job role 222 as an operator and user machine 224 of cold planer 146. As shown in FIG. 5, the operator is provided with augmented overlay 226 highlighting objects within the field of view of display screen 176 relevant to operation of cold planer 146. Indications in the screen coordinated in placement with the objects include a first notification 502 of “Area to Be Milled,” a highlighting and second notification 504 of “Obstacle-Manhole Cover” associated with manhole cover 406, a highlighting and a third notification 506 of “Safety-Steep Grade” along the border of berm 412 and right roadside 414, and a highlighting and fourth notification 508 of “Safety-Steep Grade” along the left roadside 416. As well, a highlighting and fifth notification 510 of “Safety-Overhead Power Lines” is superimposed on the overhead power lines 410. Each of these emphases within augmented overlay 226 in FIG. 5 is selected from among a larger group of possible overlays or emphases based on their direct relevance to the operation of cold planer 146 as defined by job role 222 and user machine 224, as discussed above. Therefore, only information important to and appropriate for user 150 is overlaid.

In addition to augmentation coordinated with objects within display screen 176, the modification of the mixed-reality display also includes content relating to filtered worksite data 210 not necessarily coordinated with viewed objects. For instance, display screen 176 in FIG. 5 includes sixth notification 512, which identifies performance data filtered to relate to the current work activity for user machine 224. As the performance data is not directly related to an object in the physical view, it may be displayed in any convenient location within the field of view of display screen 176.

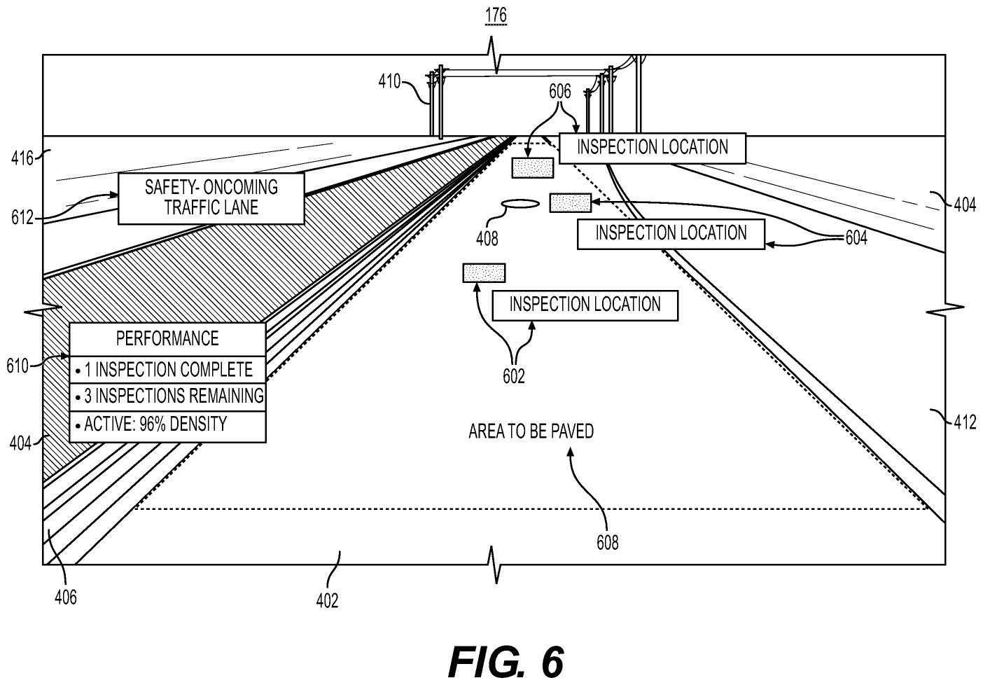

In contrast to FIG. 5, FIG. 6 illustrates an example view of the same scene in the physical world through display screen 176 with augmented reality by a jobsite inspector of a street to be paved. In this situation, job role 222 has been identified as inspector and, accordingly, no work machine is associated with user 150 of augmented-reality device 174. In this example, controller 134 or the controller within augmented-reality device 174 selects an augmented overlay 226 specific to an inspector and related to the inspector's location within the worksite. Thus, display screen 176 shows several superimposed items coordinated with objects in the real world, namely first notification 602, second notification 604, and third notification 606, which identify inspection locations for the inspector. These items are relevant to the role of the inspector in evaluating lane 402 for paving. In addition, a fourth notification 608 of “Area to Be Paved” is provided to help guide the inspector in the task. Finally, several items of filtered worksite data 210 are provided. Namely, a fifth notification of performance data filtered to relate to the current work activity for the inspector. Also, a sixth notification to warn the inspector about safety with oncoming lane 404 is provided. As the fifth and sixth notifications are not directly related to an object in the physical view, they may be displayed at any convenient location within the field of view. As hazards above the ground and at the side of the street are not a risk to an inspector, third notification 506 (steep grade), fourth notification 508 (steep grade), fifth notification 510 (overhead power lines) from FIG. 5 are filtered out and not displayed.

Returning to FIG. 3, in a final step 318, method 300 evaluates whether changes have occurred to context data 202, particularly to job role 222 or user machine 224. If not, the method continues evaluating received worksite data 210 to determine information to provide within display interface 176. If the job role 222 or user machine 224 has changed, method 300 returns to step 306 where it again evaluates context data 202 to determine a new job role 222 or user machine 224. Whether the job role is directly definable through augmented-reality device 174, looked up by controller 124, or obtained in a different fashion, a user may change from one level of responsibility to another with respect to augmented-reality device 174. For instance, after finishing a workflow, an operator of cold planer 146 may change the job role from operator to inspector. In that situation, the relevant controller would select a different augmented overlay 226 to match the new job role for user 150. As an example, the user's view within display screen 176 would change from FIG. 5 as an operator of cold planer 146 to FIG. 6 as an inspector. Similarly, the same augmented-reality device 174 could be shared with a user not affiliated with the enterprise, such as a visitor. In that instance, job role 222 would be such as to select augmented overlay 226 that provides only security information to guard against injury or unauthorized access to locations with the worksite.

Accordingly, as illustrated in FIGS. 3-6, a method of the present disclosure adapts an augmented-reality device 174 to context data related to its use, particularly for a job role for a user and a work machine associated with the user. Those of ordinary skill in the field will appreciate that the principles of this disclosure are not limited to the specific examples discussed or illustrated in the figures. For example, although discussed in terms of paving system 100, the methods and system of the present disclosure apply equally to various industrial applications, including but not limited to mining, agriculture, forestry, construction, and other industrial applications. Moreover, while primarily directed to selecting visual overlays based on a job role and machine identity, the present disclosure also applies to different types of selection and filtering being applied to other types of context data 202 as may suit the desired purposes.

### INDUSTRIAL APPLICABILITY

The present disclosure provides systems and methods for generating an overlay for a scene viewable in an augmented-reality device based at least on a job role of a user operating the augmented-reality device. The augmented-reality device obtains context data and worksite data relating to the user and a machine associated with the user. From the context data, a job role is identified for the user. Based on the job role and a machine type, an augmented overlay for a mixed-reality display is selected from a plurality of augmented overlays. The selected augmented overlay provides a superimposed emphasis on selected objects within the user's field of view and provides status data relating to a workflow being performed by the user. As a result, the user can obtain customized information tailored to the user's job role and to the machine associated with the user. Moreover, the same augmented-reality device may be configured for other users or reconfigured for the same user having a different job role or associated machine, providing efficient functionality.

As noted above with respect to FIGS. 1-6, an example method 300 includes receiving user data, identifying a user 150 of an augmented-reality device 174 at a worksite, and identifying a job role 222 for user 150 at the worksite and a user machine 224 associated with user 150 at the worksite. An electronic controller, such as 134, selects an augmented overlay 226 among a plurality of a visual overlays available for a scene viewable within the augmented-reality device 174 based at least in part on a combination of job role 222 and user machine 224. The method further includes receiving worksite data 210 relating to operation of user machine 224 by user 150 at the worksite and filtering the worksite data 212 into status data 228 based at least in part on a combination of job role 222 and user machine 224. Finally, the electronic controller causes a modification of a mixed-reality display of real-world images for the scene within a display screen 174 of the augmented-reality device 174 viewable by user 150. The modification includes the augmented overlay 226 coordinated with the real-world images and status data 228 specific to job role 222 and user machine 224.

In the examples of the present disclosure, augmented-reality device 174 is configurable to match at least the job role 222 for a user of the device. Additionally, a user machine 224 associated with user 150 can enable additional configuration of the device. At a worksite, if a user has a job role as an operator of a machine, an augmented overlay 226 specific to operation of that machine can be selected, showing hazards, work guidance, performance metrics, and other information tied to the user's job role and machine. If the user changes job role 222, or a new user has a different job role, such as a supervisor, the augmented overlay 226 for the same scene viewable by the operator may highlight different objects and present different information tied to the tasks of the supervisor. Accordingly, following the methods of the present disclosure, augmented-reality device 174 is configurable to provide the most useful information to the user based on a job role 222 and a user machine 224, and information displayed within the device can be changed to match the defined job role for different users. The augmented-reality device 174, therefore, provides more flexible use among a variety of users and provides augmentation tailored to the job functions of the user.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A computer-implemented method, comprising:
receiving, by an electronic controller, an indication of activation of an augmented-reality device associated with a user at a worksite;
obtaining context data, by the electronic controller, relating to usage of the augmented-reality device at the worksite, the context data including a user identity for the user;
identifying, by the electronic controller, a first job role associated with the user identity within the worksite for the augmented-reality device;
generating, by the electronic controller, an augmented-reality overlay for the augmented-reality device specific to the user based at least in part on the first job role; and
causing, by the electronic controller, a first modification of a mixed-reality display of real-world images for a scene within a window of the augmented-reality device viewable by the user, the first modification including the augmented-reality overlay visually coordinated with the real-world images, wherein the first modification for the scene differs between the first job role and a second job role.

2. The computer-implemented method of claim 1, further comprising:
receiving, by the electronic controller, worksite data relating to an activity of the user within the worksite;
filtering, by the electronic controller, the worksite data into job-specific data based at least in part on the first job role; and
causing, by the electronic controller, a second modification of the mixed reality display, the second modification including the job-specific data visually coordinated with the real-world images.

3. The computer-implemented method of claim 2, wherein the job-specific data comprises steps within a workflow executable by the user on the worksite within the scene.

4. The computer-implemented method of claim 1, wherein the context data further includes a machine identity for a work machine operated by the user at the worksite, the augmented-reality overlay is specific to the first job role and the machine identity, and the first modification for the scene differs between the machine identity and another machine identity.

5. The computer-implemented method of claim 4, further comprising:
obtaining updated context data, by the electronic controller, the updated context data including one of a new user identity for the user and a new machine identity for the work machine.

6. The computer-implemented method of claim 1, wherein the electronic controller is integrated within the augmented-reality device.

7. The computer-implemented method of claim 1, wherein the identifying the first job role comprises receiving an entry from the user via the augmented-reality device.

8. The computer-implemented method of claim 4, wherein the first job role is an operator, the machine identity is a ground-shaping machine, and the augmented-reality overlay includes highlighting of a ground area to be shaped.

9. The computer-implemented method of claim 1, wherein the first job role is an inspector and the augmented-reality overlay identifies locations within a ground area to be inspected.

10. A computer-implemented method, comprising:
receiving, by an electronic controller, user data identifying a user of an augmented-reality device at a worksite;
identifying, by the electronic controller, a job role for the user at the worksite;
receiving, by the electronic controller, machine data identifying a work machine associated with the user at the worksite;
selecting, by the electronic controller, a visual overlay among a plurality of a visual overlays available for a scene viewable within the augmented-reality device, the visual overlay being selected among the plurality based at least in part on a combination of the job role and the work machine;
receiving, by the electronic controller, worksite data relating to operation of the work machine by the user at the worksite;
filtering, by the electronic controller, the worksite data into status data based at least in part on a combination of the job role and the work machine; and
causing, by the electronic controller, a modification of a mixed-reality display of real-world images for the scene within a window of the augmented-reality device viewable by the user, the modification including the visual overlay coordinated with the real-world images and the status data, wherein the modification for the scene is specific to the job role and the work machine.

11. The computer-implemented method of claim 10, further comprising:
receiving, by the electronic controller, worksite data relating to an activity of the user within the worksite;
filtering, by the electronic controller, the worksite data into job-specific data based at least in part on the job role; and
causing, by the electronic controller, an additional modification of the mixed reality display, the additional modification including the job-specific data visually coordinated with the real-world images.

12. The computer-implemented method of claim 10, wherein the job role is one of supervisor, operator, and visitor.

13. The computer-implemented method of claim 10, wherein the identifying the job role comprises receiving a job entry from the user via the augmented-reality device.

14. The computer-implemented method of claim 13, further comprising, by the electronic controller, receiving a new job entry for the user via the augmented reality device, identifying a new job role for the user at the worksite, and selecting a new visual overlay among the plurality of visual overlays available for the scene based at least in part on the new job role.

15. A system, comprising:
a work machine operable on a worksite by a user;
an augmented-reality device associated with the user; and
an electronic controller, coupled to at least the augmented-reality device, the electronic controller configured to:
receive a user identity for the user of the augmented-reality device at the worksite;
identify a first job role associated with the user identity within the worksite for the augmented-reality device;
generate an augmented-reality overlay for the augmented-reality device specific to the user based at least in part on the first job role; and
cause a modification of a mixed-reality display of real-world images for a scene within a window of the augmented-reality device viewable by the user, the modification including the augmented-reality overlay visually coordinated with the real-world images, wherein the modification for the scene differs between the first job role and a second job role.

16. The system of claim 15, wherein the electronic controller is further configured to:
receive a machine identity for the work machine operated by the user,
wherein the augmented-reality overlay is generated specific to the user and the work machine based at least in part on the first job role and the machine identity.

17. The system of claim 16, wherein the augmented-reality device establishes a wireless network with the work machine, and the work machine communicates the machine identity to the augmented-reality device over the wireless network.

18. The system of claim 16, wherein the first job role is an operator, the machine identity is a ground-shaping machine, and the augmented-reality overlay includes a ground area to be shaped.

19. The system of claim 18, wherein the electronic controller is further configured to receive a second job entry for the user via the augmented reality device, to identify the second job role for the user at the worksite, and to generate a new augmented-reality overlay for the scene based at least in part on the second job role.

20. The system of claim 19, wherein the second job role is an inspector and the augmented-reality overlay identifies locations within a ground area to be inspected.
